(19) United States
(12) Patent Application Publication
(10) Pub. No.: US 2008/0255684 A1
(43) Pub. Date: Oct. 16, 2008

(54) ARTIFICIAL INTELLIGENCE DEVICE AND CORRESPONDING METHODS FOR SELECTING MACHINABILITY DATA

(75) Inventors: Shaw Voon WONG, Selangor (MY); Abdel Magid S. HAMOUDA, Selangor (MY)

Correspondence Address: LOWE HAUPTMAN HAM & BERNER, LLP, 1700 DIAGONAL ROAD, SUITE 300, ALEXANDRIA, VA, 22314, US

(73) Assignee: Universiti Putra Malaysia, Selangor (MY)

(21) Appl. No.: 12/099,926

(22) Filed: Apr. 9, 2008

Related U.S. Application Data
(63) Continuation-in-part of application No. 10/713,017, filed on Nov. 17, 2003, now abandoned.

(30) Foreign Application Priority Data
Nov. 18, 2002 (MY) P120024308

(51) Int. Cl. G05B 13/02; G05B 19/18

(52) U.S. Cl. 700/50; 700/173

(57) ABSTRACT

The present invention describes a device incorporating artificial intelligence and corresponding methods for recommending an optimal machinability data selection, especially with machine performance degradation. The device comprises of a first component, which feeds the system with necessary inputs. A second component, which is the main processing unit, acts as an inference engine to predict the outputs. The last component interprets the outputs, conveys the processed outputs to target location and converts them into necessary tasks. The inputs are identified as the machining operations, work piece material, machining tool type, and depth of cut. The input includes machine performance characteristics as well, that is the degradation level of the machine which interrelates with machine vibration and surface finishing. The outputs are the machining parameters, comprising of the optimal cutting speed and feed rate. The inference engine can be established with fuzzy logic, neural network or neural-fuzzy.

### CROSS-REFERENCE TO RELATED APPLICATIONS

The present application is a Continuation-in-Part of U.S. application Ser. No. 10/713,017, filed on Nov. 17, 2003, which in turn corresponds to Malaysian Application No. PI20024308, filed on Nov. 18, 2002, and priority is hereby claimed under 35 USC § 119 based on these applications. Each of these applications are hereby incorporated by reference in their entirety into the present application.

### FIELD OF INVENTION

The invention relates to an artificial intelligence device and corresponding methods for predicting machine performance degradation as well as selecting optimal machining parameters; especially for cutting speed and feed rate control with machine performance degradation, and more particularly applicable to computer controlled milling machines, drilling machines, grinding machines, turning machining and other such machines.

### BACKGROUND OF INVENTION

Machinability data is never defined preciously in a scientific way. Machinability data consists of the selection of the appropriate cutting tools and machining parameters, which includes cutting speed, feed rate and depth of cut. It plays an important role in the efficient utilization of machine tools and thus significantly influences the overall manufacturing costs.

The main objective of machining is to satisfy the demand of the workpiece dimensions and its surface finish. The prescription of machining parameters depends on the experience of skilled machinists. With such, numerous research works have been carried out to develop various means of predicting these parameters, besides conventional mathematical and empirical models.

However, almost all of the studies have ruled out the important factor of the machine performance; that is the influence of aging effect. When a machine is getting old, it no longer performs as it was still new. This has been identified as degradation. Many complicated factors come into consideration; such as the utilization rate, the way the machine being used and any cooling period in between. With such, the prediction model and studies conducted based on a typical machine will deviate at various age of the machine. In another words, whatever optimum result obtained is not always optimum. Therefore selection of different machining parameters is required in order to yield similar output quality (machine performance) at different age. Thus, it is needed to establish a proper performance prediction model for machining, which incorporates age of the machine as well as the tool as a dynamic factor, either directly or indirectly.

With human operator, this problem is not of very serious. But, for computer-controlled machine, where the machining parameters are prescribed/recommended by the CAM system, the machinist will do certain fine-tuning based on his/her experience. Degradation of the machine largely affects the effort to put into this fine-tuning process. This is due to the fact that the present CAM system always recommends the same value for the same “configurations” without considering the condition of the real machine. That is why till to-date, fully-automated prescription of machining parameters is still a dream to be materialized.

The quality of surface finish of workpiece is an important requirement in machining operation. Thus, the choice of optimized cutting parameters is very important for controlling the required surface quality. The capability of producing good surface finishing is one of the machine performances. Many efforts have been directed to achieve better surface finishing. Again, none incorporate the effect of machine degradation as one of the important factors.

The general practice of experienced machinists is captured, formalized and made available in the form of machining data handbook, data sheets and charts, nomograms and slide rules. Metcut's Machining Data Handbook (MDH) is among the common sources. The data in the handbook were separated into different types of machining process, such as face milling, end milling, turning, boring, etc. The data were grouped according to the types of workpiece material and the respective hardness. The handbook provides the speed of cut and the feed rate corresponding to the depth of cut. For each workpiece material and hardness, one may scan through different possible tool materials. Then, speed and feed rate are selected according to tool-workpiece material combination, depth of cut, and finishing condition. Although handbook approach is often a logical and effective solution to the requirements of machinability data, it has the following limitations:
Handbook recommendations represent a starting set of cutting conditions and hence tend to be conservative in order to cope with a worst-case machining scenario.
Handbook data only applies to a particular machining situation. This data may not be suitable for slightly different machining situation.
Handbooks are manually input-output oriented, and hence lack compatibility with the objective of integrated automation of the manufacturing system.
   Furthermore, the effect of machine degradation is not incorporated.

Artificial intelligence (AI) is normally referred as any operation being carried out based on the wistful hope that at least some of the flexibility and power of the human brain can be reproduced by artificial means. The characteristics of brain function have inspired the development of artificial neural network. The way of human making decision and analyzing in real life has inspired the development of fuzzy logic. The experience of the machining operators may express in terms of fuzzy logic and/or modeled with artificial neural networks.

Turning operation of wrought carbon steel with different cutting tools has been modeled successfully with artificial neural networks and the fuzzy reasoning has shown promising results in prior-arts by the inventor. The methods are further generalized in the present invention to cover all machining process with different work piece materials and cutting tools.

### SUMMARY OF INVENTION

Accordingly, it is a first object of the present invention to provide an artificial intelligence device and corresponding artificial intelligence methods which provides a better solution compared to traditional methods for selecting optimal machinability data, especially with machine performance degradation.

The present invention comprises of the three main embodiments. The proposed systems works with different or combination of different AI methods. Among them are Fuzzy Logic, Neural Networks and Genetic Algorithm. The embodiment will carry different function for different AI models.

In a first aspect of the present invention, the device comprises of Input Component, Inference Engine, and Output Component. The Input Component comprises of different input interfaces, means to store and manipulate the collected inputs. The corresponding input manipulation depends on the method incorporated in the inference engine. The Inference Engine will process the input and prescribe the outputs in respective form depending on the AI model incorporated. The yielded outputs, which are the recommended initial cutting parameters, will be further processed by the Output Component. The output will then be further processed to turn into required form and format. The transformed output will then be fed into the machine for further action by the machine.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a block diagram showing the Machinability Data Selection System with Artificial Intelligence.

FIG. 2 is the inputs fuzzy expression.

FIG. 3 is the output fuzzy expression for cutting speed fuzzy model.

FIG. 4 is the min-max range of fuzzy membership functions for cutting speed fuzzy model.

FIG. 5 is the Fuzzy rules for high-speed steel fuzzy model.

FIG. 6 is the Fuzzy rules for uncoated brazed carbide fuzzy model.

FIG. 7 is the Fuzzy rules for uncoated indexable carbide fuzzy model.

FIG. 8 is the Fuzzy rules for coated carbide fuzzy model.

FIG. 9 is the fuzzy expression for machine degradation fuzzy model.

FIG. 10 is a block diagram showing how machine degradation involves in machinability data selection.

FIG. 11 is a diagram showing the neural-fuzzy model for machinability data selection.

FIG. 12 is the input and output membership functions for high-speed steel feed rate fuzzy model.

FIG. 13 is a flow chart for general system of fuzzy rules genetic optimization.

FIG. 14 is a block diagram of simple non-linear neural network of machinability data for turning

### DETAILED DESCRIPTION OF THE INVENTION

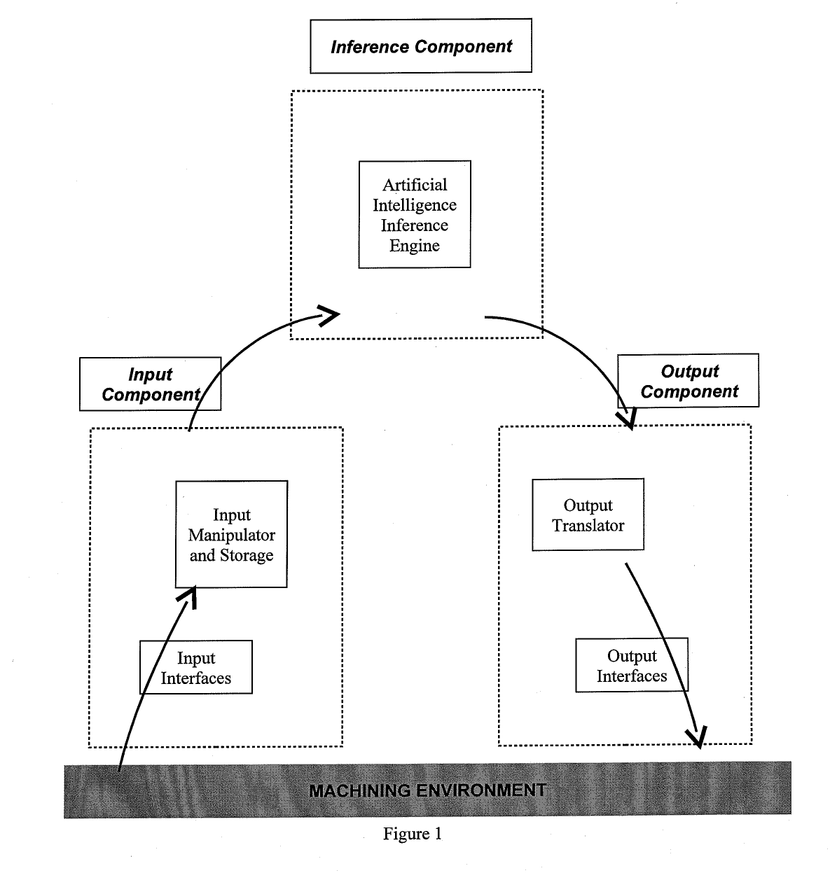

With reference to FIG. 1, the basic aspect of this invention is the use of Artificial Intelligence techniques for selecting optimal machining parameters, especially with machine performance degradation in conventional machining operations. The device comprises of three main components which are the input, the inference engine and the output.

The inputs are the machining operations, workpiece material, machining tool type and depth of cut. This includes machine performance characteristics as well; that is the degradation level of the machine which interrelates with machine vibration and surface finishing. The outputs are the machining parameters comprising of the optimal cutting speed and feed rate. The inference engine can be established using AI techniques such as fuzzy logic, neural network or neural-fuzzy.

In the first embodiment, there are three basic components for a typical fuzzy expert system which are input fuzzification, rules application (or inference engine) and output defuzzification. The input fuzzification translates the system-input variables into universe of input memberships. There are two common methods used for an inference engine which are Max-Product method and Max-Min inference method. The difference is the aggregation of the rules. They use multiplication and truncation of the output fuzzy set with the yielded result respectively. The defuzzification process is defined as the conversion of a fuzzy quantity, represented by a membership function, to a crisp or precise quantity. There are two common methods for defuzzification of fuzzy quantities which are the Max method and Centroid method. Two separate models have been developed to yield the desired output for wrought carbon steel turning process; which are the Cutting Speed Fuzzy Model and the Feed Rate Fuzzy Model.

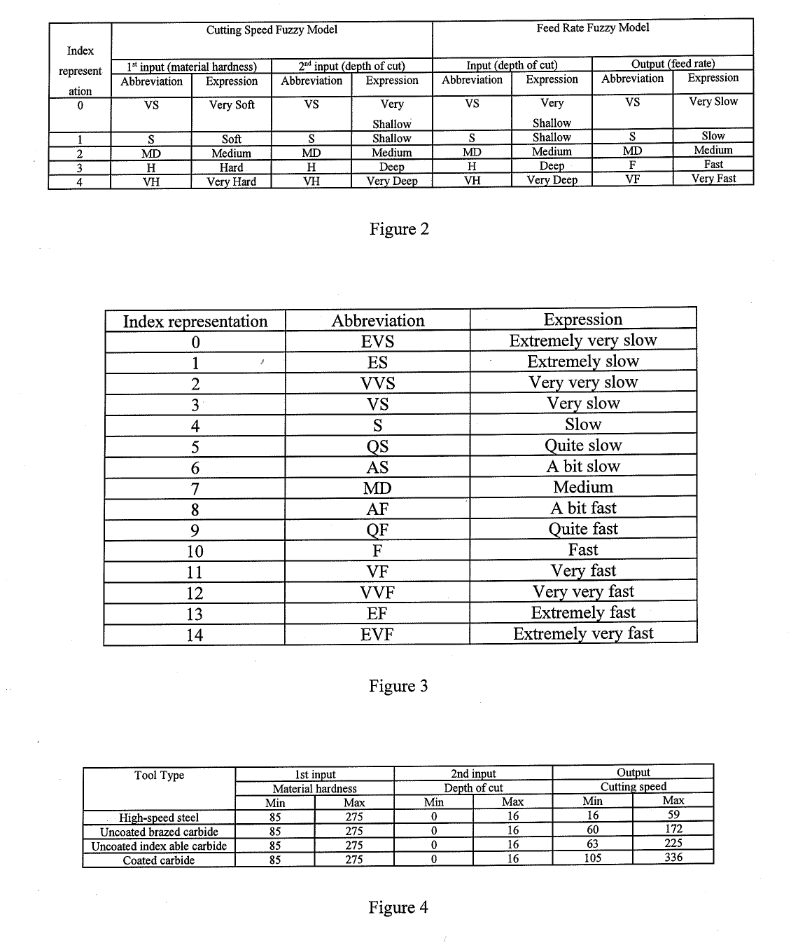

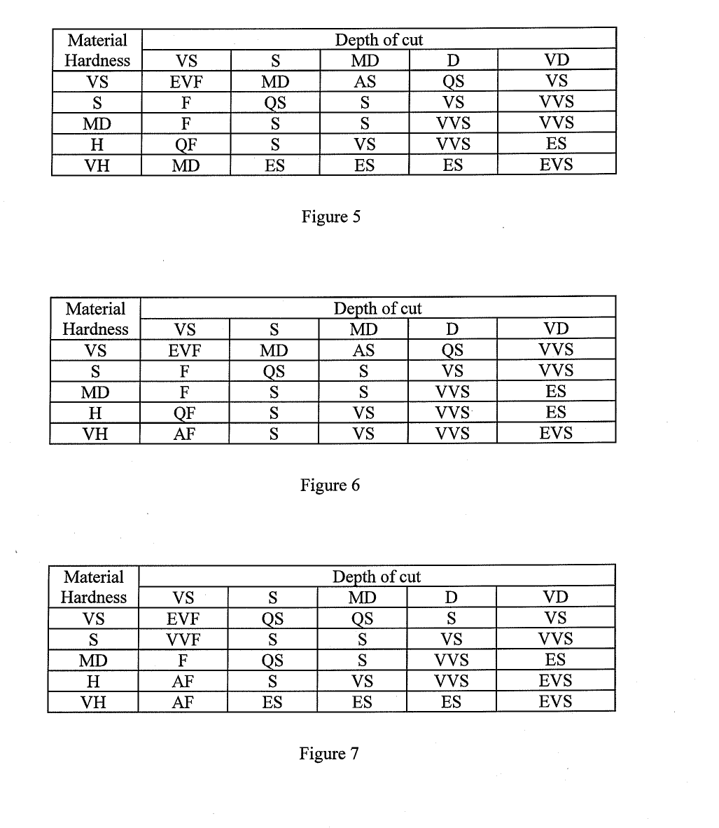

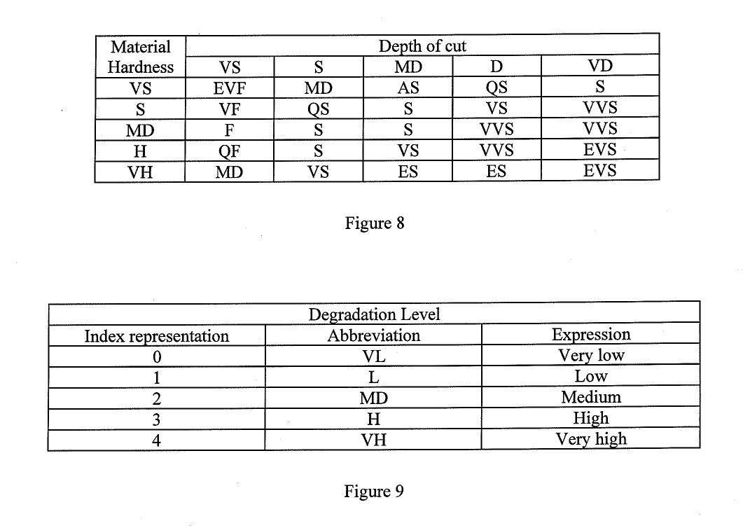

For the Cutting Speed Fuzzy Model, the hardness of workpiece material and the depth of cut are the inputs and cutting speed is the output of the fuzzy model. FIGS. 2 and 3 show the fuzzy expressions for work piece material hardness, depth of cut and cutting speed respectively. FIG. 4 shows the range of the fuzzy input membership functions and the output membership functions. All membership functions (both inputs and outputs for all models) are of triangle shape and are well distributed. Four fuzzy models with different fuzzy rules amongst themselves are developed. The first model with fuzzy rules shown in FIG. 5 was designed for high-speed steel tool. Other models were then designed to get optimum result (cutting speed) for uncoated indexable carbide tool, uncoated brazed carbide tool and a coated carbide tool. The rules set for these tools are shown in FIG. 5 to 8. The search for the optimum model for every cutting tool has been limited to the variance in rules only, where the input and output fuzzy sets are maintained and linearly proportionate among two types.

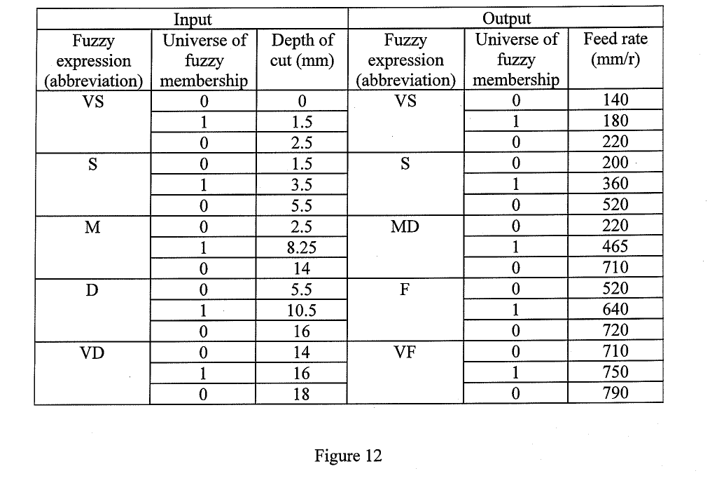

The Feed Rate Fuzzy Model is a single-input-single-single-output fuzzy model. The fuzzy shape of the input and output fuzzy sets is that of a triangle, but not of an equal-sided triangle. FIG. 12 shows the fuzzy expression for both the input and output membership functions. The model applies straightforward fuzzy rules, which are

i. If the depth of cut is very shallow then the feed rate is very slow
ii. If the depth of cut is shallow, then the feed rate is slow
iii. If the depth of cut is medium, then the feed rate is medium.
iv. If the depth of cut is deep, then the feed rate is fast
v. If the depth of cut is very deep then the feed rate is very fast
Unlike the Cutting Speed Fuzzy Model, the Feed Rate Fuzzy model maintain the fuzzy rules as a common rule while changing the input and output membership functions in order to yield the best results. The high-speed steel fuzzy model is set as the reference membership function throughout the new membership function development for other tools.

The following equation E1 is used to define the input and output fuzzy sets of other tool type models.

$${V}_{new} = {V}_{new , min} + {( \frac{{V}_{std} - {V}_{std , min}}{{V}_{std , max} - {V}_{std , min}} )}^{n} \times ( {V}_{new , max} - {V}_{new , min} ) \qquad E1$$

The corresponding new value of a membership function (input and output as well), V_{new} is yielded from the value of the input and output membership functions of the High-Speed Fuzzy Model, V_{std} (so named reference fuzzy model), V_{new,max}, V_{new,min}, V_{std,max} and V_{std,min} are the maximum and minimum value of the new membership functions and the standard membership functions. The exponential value, n, will determine the pattern of the yielded membership function. n=1 will lead to a linear proportional relationship. To obtain a better correlation, the value of n is obtained from Equation E2 instead of being a constant.

$$n = \{ \begin{matrix}A - {( \frac{{V}_{std} - {V}_{std , min}}{( {V}_{std , max} - {V}_{std , min} ) \times R} )}^{{P}_{1}} \times ( A - B ) , \\ {\_V}_{std} \leq {V}_{std , min} + ( {V}_{std , max} - {V}_{std , min} ) \times R \\ 1 - \frac{{V}_{std , min} + ( {V}_{std , max} - {V}_{std , min} ) - {V}_{std}}{( {V}_{std , max} - {V}_{std , min} ) \times {( 1 - R )}^{{P}_{2}} \times {( A - B )}^{′}} \\ {\_V}_{std} > {V}_{std , min} + ( {V}_{std , max} - {V}_{std , min} ) \times R\end{matrix} \qquad E2$$

The value n will be equal to A at the lowest V_{std} valued and gradually decrease to B (which must be a value smaller than unity) when V_{std} is at the required ratio of the range, R. The changing pattern of n is dependant on the constant P₁. Then n will gradually increase to unity at the maximum value of V_{std}. Again, the changing pattern of n is depending on constant P₂.

When machine degradation is utilized as input, the fuzzy expressions shown in FIG. 9 would be used. The fuzzy expression “Very low” indicates that the machine is affected from very little degradation in performance, whereas the fuzzy expression “Very high” indicates otherwise. The range of the fuzzy membership functions for degradation is determined with respect to the vibration response of the machine performing machining operation.

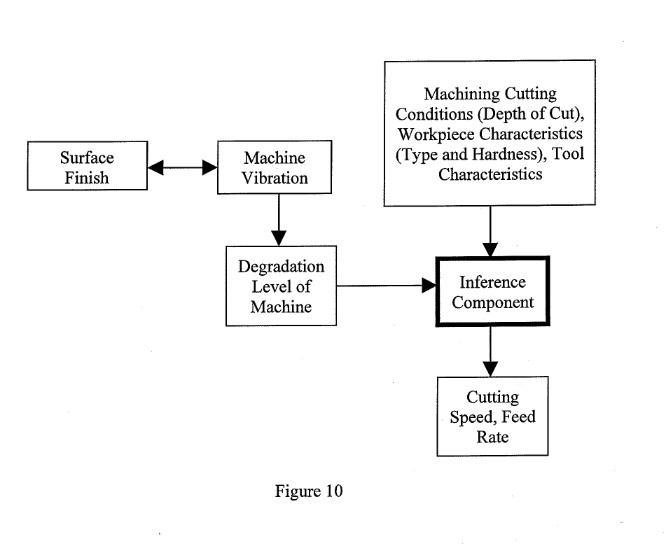

FIG. 10 shows how the degradation level of the machine performance is involved in prescribing machining data. The degradation level of the machine is inserted as one of the inputs; together with other inputs (machining cutting conditions, workpiece characteristic and tool characteristic) into the inference component of artificial intelligence. Basically, the inference component is an adaptive prediction model, based on the first and third embodiments of the invention. This model is known as a hybrid neural-fuzzy model; which will evolve while gaining serving data of the machine. The model will learn and adapt to the degradation of the machine in order to achieve the desirable surface finish.

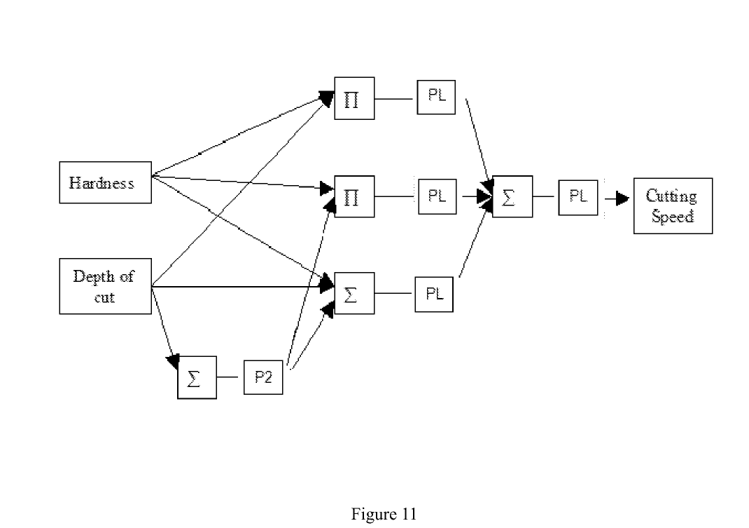

The neural-fuzzy model is consisted of five layers; which the nodes could be generally divided into input nodes, input term nodes, rule nodes, output term nodes and output nodes such as shown in FIG. 11.

In layer 1, the nodes are known as input linguistic nodes; which directly send input variables to the next layer for fuzzification. Whereas, nodes in layer 2 and 4 are term nodes (input and output respectively) functioning as membership functions to express the input and output fuzzy variables. Layer 3 consists of rule nodes which define the preconditions of the rules, while each node in layer 4 represents a possible consequence of a fuzzy rule. Nodes in layer 5 represent the output variables of the system, where defuzzification is performed.

Triangular membership functions are used in this model; whereby the degree of membership for triangular membership function, y is calculated as in Equation E3.

$$y = \{ \begin{matrix}0 , & if x \leq a \\ 1 - \frac{b - x}{b - a} , & if a \leq x \leq b \\ 1 - \frac{x - b}{c - b} , & if b \leq x \leq c \\ 0 , & if x \geq c\end{matrix} \qquad E3$$

The value x in Equation E3 is the value of the input and the value b is the center of the triangular membership function. b−a and c−b are widths of left and right of the bisected asymmetrical triangles respectively. The parameters in the membership functions would be updated through learning process. Membership functions can be initialized as uniformly distributed triangular membership functions if the information required, are not readily available. If expert knowledge is available, then this knowledge can be used to initialize the membership function. In layer 5, weighted centroid method is used for defuzzification to yield the final output.

To tune the parameters of the membership functions optimally, the steepest descent method described in the third embodiment of the invention is applied. Through this method, the system would be able to adapt to different environment settings. The system would adjust its weights to minimize the error between the predicted and the actual outputs during the training process.

The degradation level of the machine performance is predicted through another prediction model based on neural network (third embodiment). This model is characterized by the relationship between vibration and degradation of the machine; as well as the surface finish. Surface finishing is another vital element in determining machine degradation, with respect to machine vibration. Another model is realized through neural network (third embodiment) to predict the surface finish, characterized by the relationship between machine vibration and surface finishing.

In the second embodiment, the genetic optimization is used to further optimize the fuzzy rules. Major operations of genetic algorithm depend on random choice. A random number generator class is developed. It consists of three main functions.

They are: to generate a random real number from 0 to 1, to generate a random number from a user given start to a user given end integer value and to give green or red light for a user given probability.

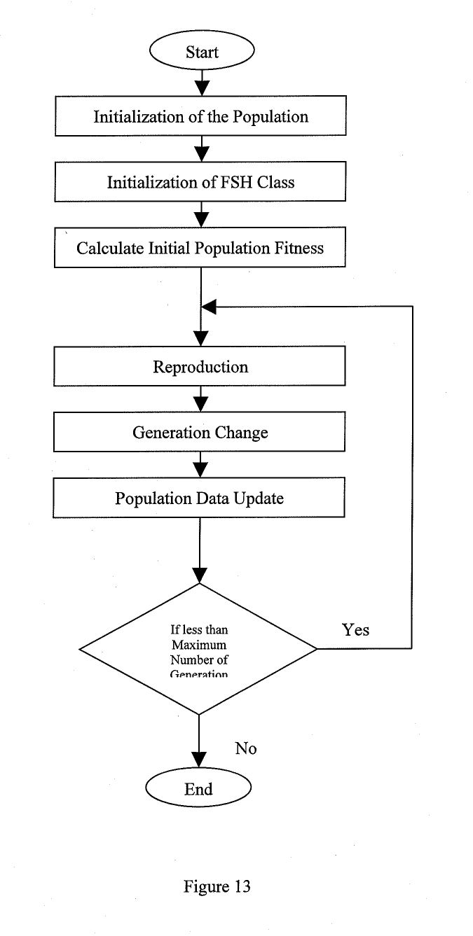

Genetic optimization of fuzzy rules has been carried out with the help of an object oriented genetic optimization library (GOL). It consists of several useful and inter-connected classes. To evaluate the fuzzy result, the Fuzzy Set Handling (FSH) class has to be included. FIG. 13 shows a general system flow of the genetic optimization process for fuzzy rules design.

The population needs to be initialized. Information such as the number of alleles and the length of each allele are predetermined. The GOL use bit-wise interpretation, which means, the length of a particular allele is expressed in term of bit. If an allele carries a possible value from 0 to 7 (or 8 possible features), the length of allele is 3. The fuzzy models consist of 5 fuzzy sets for all inputs and 15 fuzzy output sets. The system required 25 fuzzy rules with 15 possibilities each. For initialization, 25 alleles are required and the length of each allele will be 4 bits to cope with 15 possible values. Besides initialization of the alleles, the probabilities of crossover and mutation, and the size of population are needed. Proper size of the population and probabilities will yield better optimization results in terms of speed.

The population consists of 80 sets of fuzzy rules. The crossover and mutation probabilities are set as 0.6 and 0.009, respectively. The initial members of the population are required. The fuzzy rules from Fuzzy Logic are assigned as one of the initial members. The rest of the rules are generated automatically and randomly. Initialization of FSH class in FIG. 13, referring to the construction of the FSH class includes building then membership functions of inputs and output. With the FSH class, the fitness of each member of the initial population has to be calculated. The one with better fitness stands a better chance of success in reproduction. In the process, crossover and mutations may occur and thus, create new species. Crossover operation is single-point operation. The mutation operation is a random change in an allele, instead of a bit in the allele. The new generation has a tendency towards better quality. The reproduction continues until the population is completed. The whole process repeats until the maximum number of generation is obtained. Fitness is obtained through Equation E4.

$$Fitness = K - {\sum }_{i = 0}^{n} \frac{{( abs\_error \% )}_{i}}{n + 1} - \sum error\_factor \qquad E4$$

The value of i in E4 is the numbering of the predetermined inputs starts from 0. Thus, value n is the ending number of the predetermined inputs, in this case 79. Error factor is for rules violation penalty. The value K is arbitrarily selected positive value. It must be foreseen to be more than then achievable maximum summation of the absolute error percentage mean and the error factors. Generally, with lower mean absolute error percentage, the fitness value is higher and nearer to K. For the final consideration of the fitness in the competition of reproduction selection, Equation E5 is employed.

FFitnessᵢ=Fitnessᵢ−min(Fitness₀ . . . Fitnessₙ) E5

The Genetic Optimization Class allows control of fuzzy rules pattern, which means that the designer can provide his/her expertise in specifying the relationship between the inputs and the outputs. Each violation will cause a penalty value, thus more violations will cause lower fitness. The user can set the penalty value. The penalty value must not be too small, which will not cause a significant effect. It must not be too large either, which will make the whole optimization process inefficient. The summation of all penalty values must not be greater than the difference between value of K and the mean of all absolute error percentage.

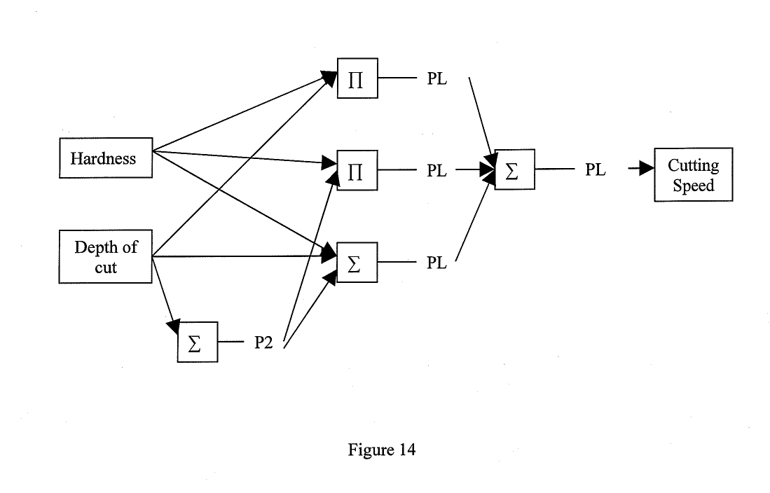

In the third embodiment, a non-linear artificial neural network, which consists of both the novel product neurons developed by the inventor and the common summation neurons, is designed to prescribe machinability data for turning process of wrought carbon steel with different tools. Two feed-forward neural networks are suggested. FIG. 14 shows the artificial neural network suggested. The network incorporates simple non-linearity of second input (the depth of cut). Two different neurons are indicated with different symbols, with “Σ” representing normal summation neuron and “π” representing the new Product Neuron. Transfer function of respective neuron is placed following the neuron symbol. “PL” stands for pure linear transfer function and ‘P2’ stands for squared transfer function. The design of the network depends on the relationships among the parameters. The artificial neural networks suggested are supervised feed forward networks. No closed synaptic loop is used.

Summation neuron is the classical neuron, which is used in most of the present neural systems. A neuron with R inputs and bias, b has the network summation value, n computed by the following equation:

n=Wp+b

where W and p are the weight matrix and input matrix, which store corresponding weights and input values respectively. The transfer function, f may be a linear or non-linear function of n. The output neuron, a, can be written as below:

$$\begin{matrix}a = f ( n ) \\ = f ( Wp + b )\end{matrix}$$

Product neuron is introduced by the inventors to deal with non-linearity and establish cross-neuron relations in a simpler way. The neuron may be hooked with multiple neurons but only weighted once. Similar to summation neuron, it holds a bias as an independent variable. The n is calculated with Equation E6.

### E6

$$n = ( {\prod }_{i = 0}^{R} {P}_{i} ) w + b$$

To avoid complication in design of learning methodology and data storage, the neuron is deliberately planned to have one overall weight, instead of individual weight of each input. Thus, processing (including learning) of a single Product Neuron is simpler than processing a summation neuron.

The final output(s) of the network are computed with propagation forward through the network from the input(s). The forward propagation process can be expressed with the Equations 7, 8 and 9, where a^{m} is the output matrix of all neurons in layer m. The initial matrix a⁰ represents the input values. The outputs of the whole network, which has M layers, are gathered as matrix a. The matrix f^{m} collects transfer functions of all neurons in layer m.

a⁰=p E7

a^{m}=f^{m}(W^{m}a^{m-1}+b^{m}) for m=1,2 . . . , M E8

a=a^{M} E9

The back propagation algorithm is a generalization of the least mean squared method to provide learning ability to the network. It is capable of handling multi layer network. The classical back propagation algorithm is summarized in this section.

The first step of the algorithm is to find the final output of the network with forward propagation. Then the sensitivity of each neuron is calculated with backward propagation through the network from the outermost layer, which yields the output(s). Recurrence relation is established among the neurons and chain rules are used to obtain the sensitivities. The neuron sensitivities of last layer are calculated Equation E10 in matrix form.

s^{M}=−2F^{m}(n^{M})(t−1) E10

Matrix t consists of all target outputs. The F^{M} (n^{M}) is the sensitivity function of respective neuron and is expressed as the Equation 11, where Sm is the number of neurons in layer m. For other layers, the Equation 12 is used.

$$\begin{matrix}{F}^{m} ( {n}^{m} ) = [ \begin{matrix}\frac{\partial {f}^{m} ( {n}_{1}^{m}}{\partial {n}_{1}^{m}} & 0 & … & 0 \\ 0 & \frac{\partial {f}^{m} ( {n}_{2}^{m}}{\partial {n}_{2}^{m}} & … & 0 \\ ⋮ & ⋮ & & ⋮ \\ 0 & 0 & … & \frac{\partial {f}^{m} ( {n}_{s}^{m}}{\partial {n}_{s}^{m}}\end{matrix} ] & E11 \\ {s}^{m} = {F}^{m} ( {n}^{m} ) {( {W}^{m + 1} )}^{T} {s}^{m + 1} & E12\end{matrix}$$

Finally the weights and biases are updated with selected update method, which may be referred as learning algorithm.

Weights and biases are updated with Approximate Steepest Descent method in this paper. The weights and biases are updated as shown in Equations 13 and 14.

W^{m}(k+1)=W^{m}(k)−αs^{m}(a^{m-1})^{t} E13

b^{m}(k+1)=b^{m}(k)−αs^{m} E14

Momentum is used to smooth out the oscillations in the trajectory towards the optimum location. Equations 15 and 16 are used to achieve such task, where ΔW^{m}(k) and Δb^{m}(k) are the kth change of weights and biases at layer m. The learning rate and the momentum coefficient are denoted as α and γ respectively.

ΔW^{m}(k)=γΔW^{m}(k−1)−(1−γ)αs^{m}(a^{m-1})^{T} E15

Δb^{m}(k)=γΔb^{m}(k−1)−(1−γ)αs^{m} E16

From the mathematical point of view, the BP learning with SD method only promises a general minima achievement, may it be a global, local or weak minima. It is guaranteed to converge to a solution that minimizes the mean squared error, as long as the learning rate is not too large. Typically, the initial weights and biases are chosen to be small random values. In this way, one can stay away from a possible saddle point at the origin. It is also useful to try several different guesses in order to be sure that the algorithm converges to a global minimum point.

A new retraining scheme is suggested to move the solution away from any local or weak minima during the training of an artificial neural network. If the network is found having weak response towards a particular training set, extra retraining are enforced until the network's performance index of the training set is under a predefined index of the training set is under a predefined-level, σ. Generally, implementation of the scheme incurs certain level of interruption towards the network (refer to the weight and bias values). Thus, one may still observe a sudden fluctuation on the performance surface even the solution reached its global minima. This can be solved by incorporating a simple global-minima tracking procedure. Implementation of the RR does not require Variable Learning Rate (VLR) algorithm. The involvement of the VLR will slow the overall efficiency of the RR scheme, as the main purpose of the RR scheme is to bring the solution out of the loal or weak minima towards the global minima. Initial studies by the inventors show that the VLR with RR cannot bring the solution out of the local or weak minima efficiently. The RR scheme requires a stable learning rate to obtain overall effect during the training process. The SD method alone is good enough to carry the task. The squared error limit, σ, is calculated with Equation 16, where σᵢₙᵢₜᵢₐₗ and σ_{end} are the user defined values which indicate the squared error limit at the initial and the end of the training respectively. iTrain and iTrainₘₐₓ are the current number of training and the maximum number of training desired respectively. As general practice, the value of σᵢₙᵢₜᵢₐₗ should be larger than σ_{end}.

$$σ = \frac{{σ}_{initial} - ( {σ}_{end} - {σ}_{initial} l ) \times iTrain}{{iTrain}_{max}} \qquad E17$$

The scope of the invention should be defined only in accordance with the claims that follow. In the following claims, reference characters used to designate claim steps are provided for convenience of description only, and are not intended to imply any particular order for performing the steps.

1. A numerical control apparatus for controlling machinability data selection in a machining environment, comprising:
means operative in response to crisp input data of a machine performance; the input data comprising machine performance characteristic data including at least a degradation level of the machine;
means of performing fuzzifications of said input data to produce fuzzy input data;
an inference component operative to produce fuzzy output data from said fuzzy input data, the inference component including a multilayer neural network and fuzzy control means for applying a set of predefined fuzzy rules to said fuzzy input data as to produce said output data, wherein the fuzzy output data comprises machining conditions including at least cutting speed data;
means of performing defuzzification of said output data to produce crisp output; and
means of conveying said crisp output data to said machining environment.

2. The numerical control apparatus according to claim 1, wherein said fuzzy rules are optimized according to a genetic algorithm.

3. The numerical control apparatus according to claim 1, wherein said multilayer neural network comprises a network of summation neurons and product neurons.

4. The numerical control apparatus according to claim 1, wherein said input data interrelates with a machine vibration.

5. The numerical control apparatus according to claim 1, wherein said input data interrelates with a surface finishing.

6. The numerical control apparatus according to claim 1, wherein said input data further comprises tool characteristic data, workpiece characteristic data and machining condition data.

7. The numerical control apparatus according to claim 1, wherein said input data further comprises cutting speed data, feed rate data, tool material data, and depth of cut data.

8. A numerical control apparatus for controlling machinability data selection in a machining environment, comprising:
means operative in response to input data of a machine performance; the input data comprising machining performance characteristic data including at least a machining vibration;
an inference component including a multilayer neural network operative to produce output data according to said input data, the multilayer neural network comprising a network of summation neurons and product neurons, the output data comprising machining condition data including at least degradation level data; and
means of conveying said output data to said machining environment.

9. The numerical control apparatus according to claim 8, wherein said input data interrelates with a surface finishing.

10. The numerical control apparatus according to claim 8, wherein said input data further comprises tool characteristic data, workpiece characteristic data and machining condition data.

11. The numerical control apparatus according to claim 8, wherein said input data further comprises cutting speed data, feed rate data, tool material data, and depth of cut data.

12. A numerical control apparatus for controlling machinability data selection in a machining environment, comprising:
means operative in response to input data of a machine performance; the input data comprising machining performance characteristic data including at least a machining vibration;
an inference component including a multilayer neural network operative to produce output data according to said input data, the multilayer neural network comprising a network of summation neurons and product neurons, the output data comprising machining condition data including at least surface finishing data; and
means of conveying said output data to said machining environment.

13. The numerical control apparatus according to claim 12, wherein said input data further comprises tool characteristic data, workpiece characteristic data and machining condition data.

14. The numerical control apparatus according to claim 12, wherein said input data further comprises cutting speed data, feed rate data, tool material data, and depth of cut data.

15. The numerical control apparatus according to claim 4, wherein said input data interrelates with a surface finishing.
